(19) United States
(12) Patent Application Publication
(10) Pub. No.: US 2012/0324755 A1
(43) Pub. Date: Dec. 27, 2012

(54) Combination hair-hand dryer assembly, and blow drying method

(76) Inventor: Shuai Zhao, Elgin, IL (US)

(21) Appl. No.: 13/135,150

(22) Filed: Jun. 27, 2011

(51) Int. Cl. F26B 25/18

(52) U.S. Cl. 34/427; 34/239

(57) ABSTRACT

A combination dryer assembly enables a user to selectively dry articles either in a hand-held, dynamic drying mode or an assembly-held, static drying mode. The dryer assembly incorporates a blow dryer apparatus, and a blow dryer retainer assembly. The blow dryer apparatus comprises an air-forcer for directing air; air conduit for conducting directed air along an air flow axis; and apparatus circuitry for powering said air-forcer. The retainer assembly comprises a conduit position mechanism for selectively positioning said air conduit; a position switch for switching apparatus-driving circuitry when said air conduit is positioned by said conduit positioning mechanism; and apparatus-driving circuitry for selectively and electrically powering the blow dryer apparatus either in a hand-held, dynamic drying mode or an assembly-held, static drying mode. The apparatus and apparatus-driving circuitry are electrically communicable with one another and a power source for powering the blow dryer apparatus.

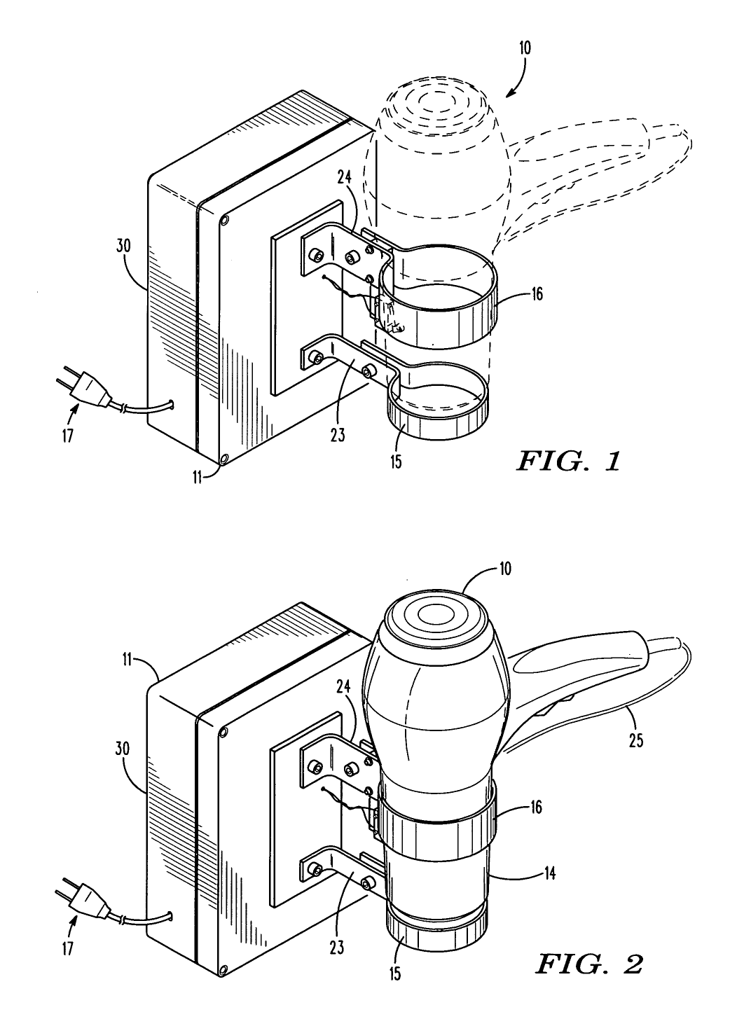

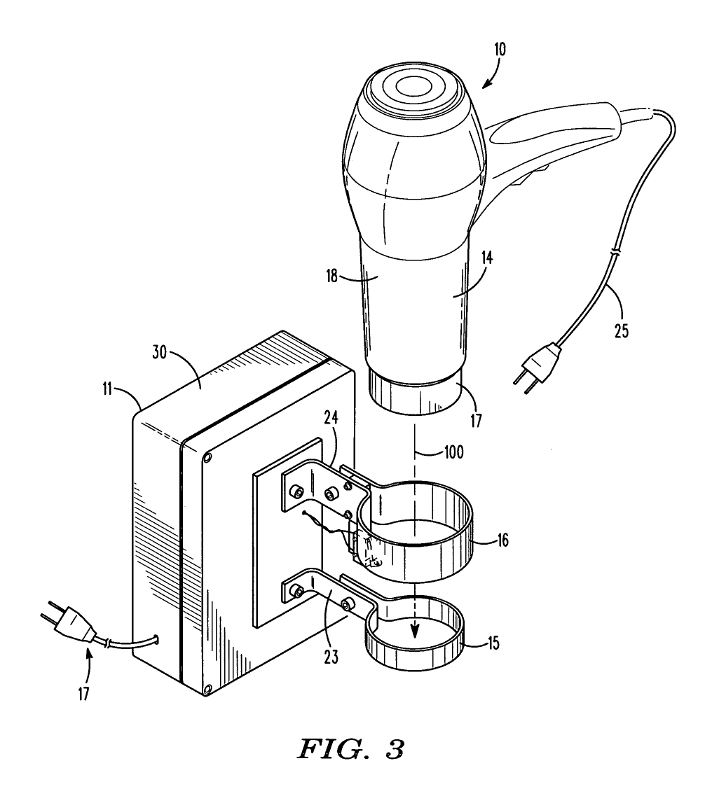

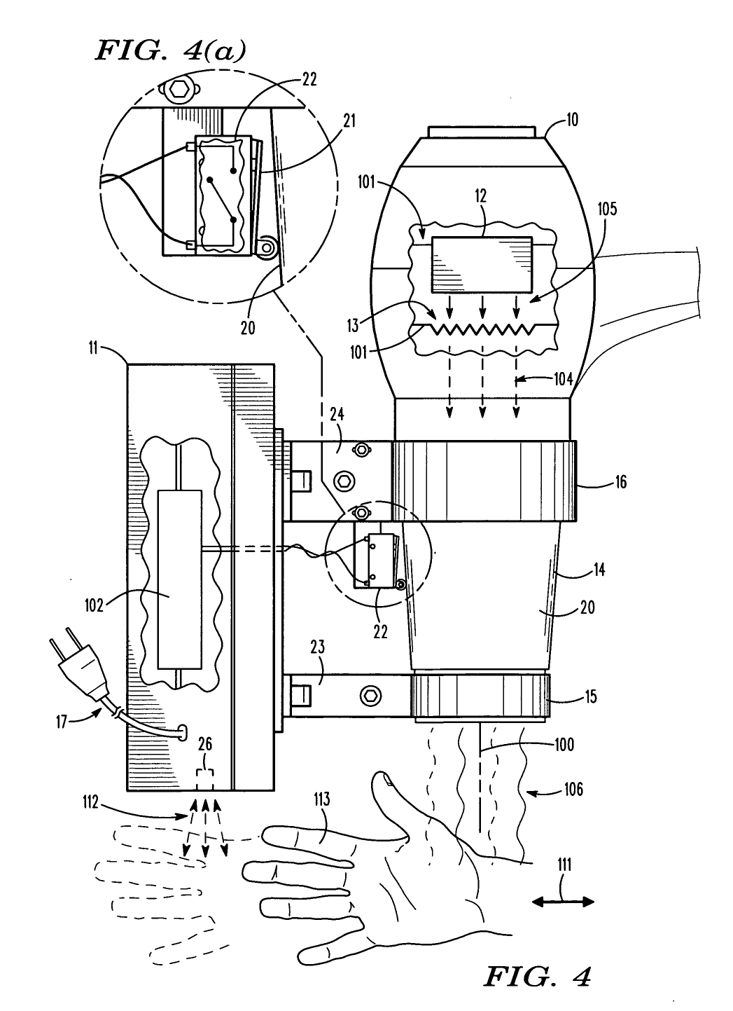

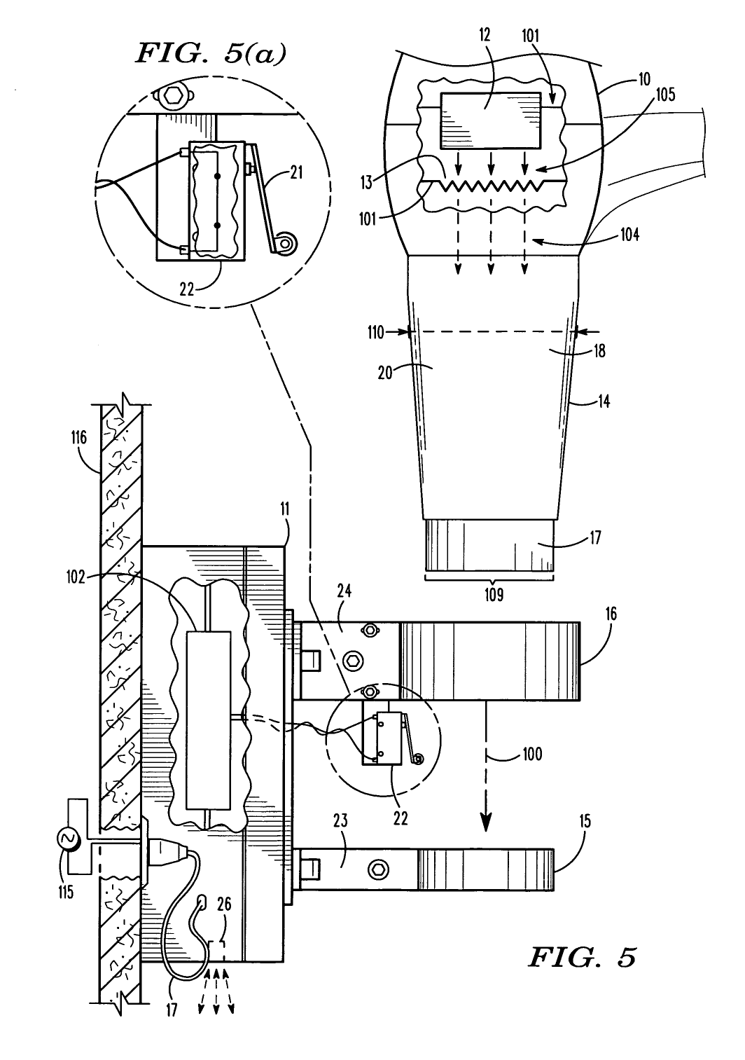

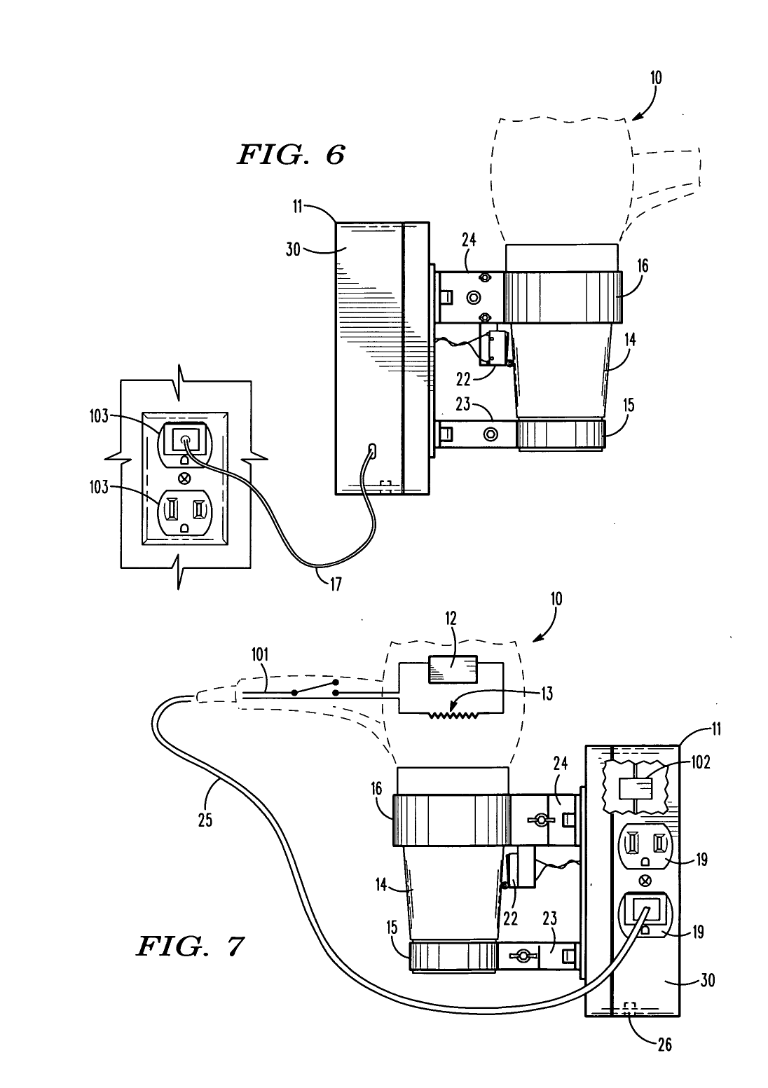

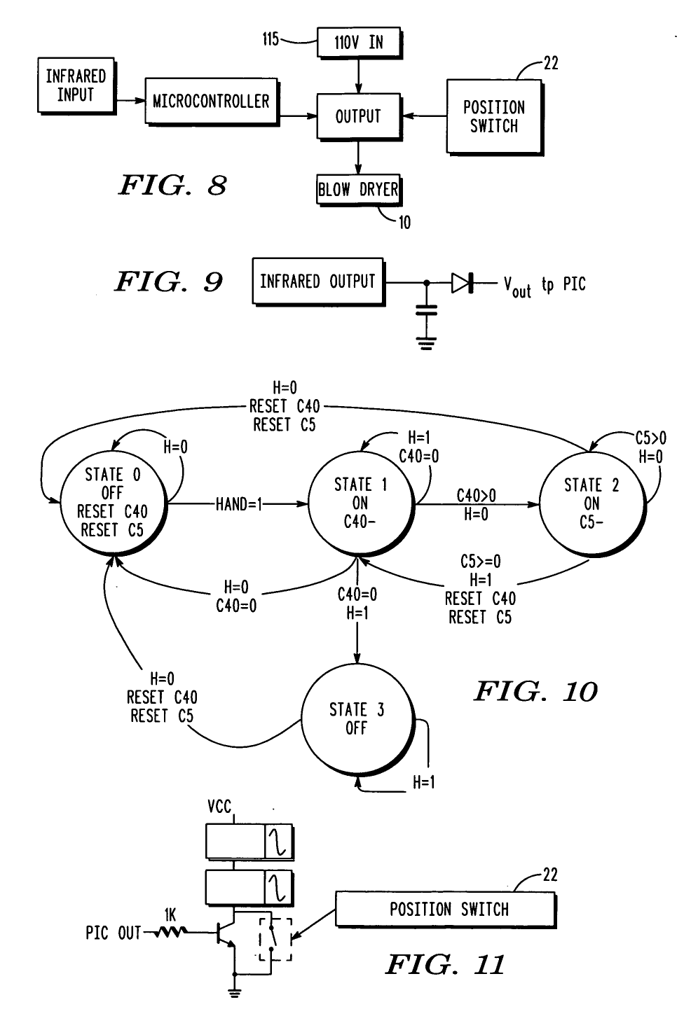

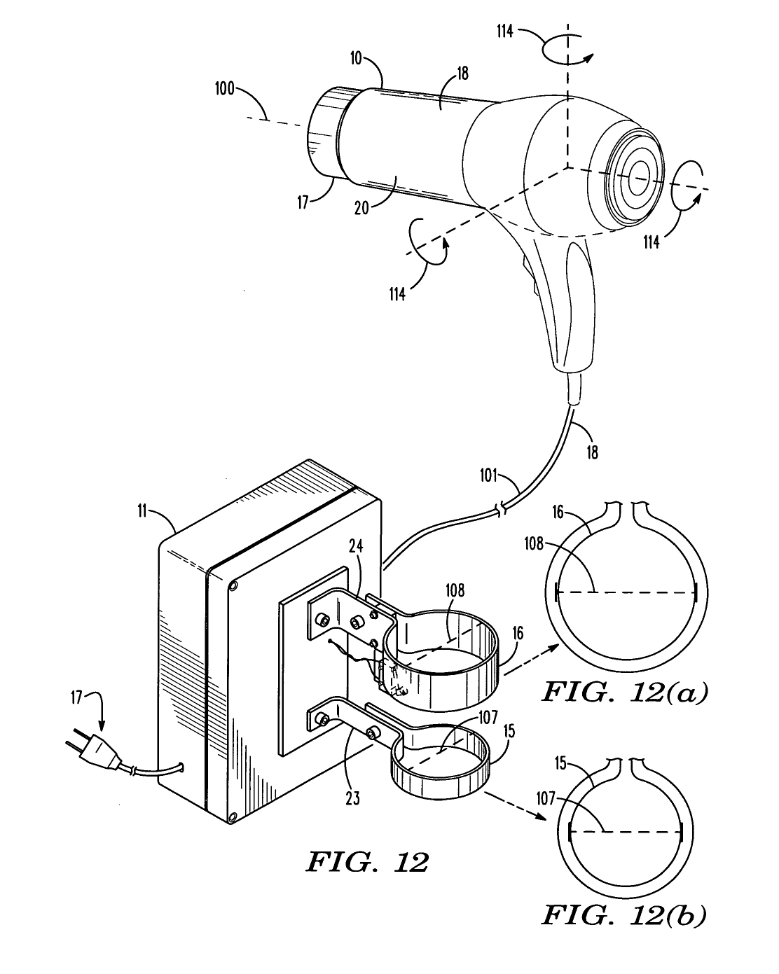

### BACKGROUND OF THE INVENTION

1. Field of the Invention

The present invention generally relates to assembly for releasably retaining a portable, hand-held hair or blow dryer in a powered-up, ready-for-use state. More particularly, the present invention relates to an assembly and method for expanding the functionality of a portable, hand-held hair or blow dryer when not in dynamically hand-held use to a statically mounted, motion-dependent dryer for drying articles passed before the hot air outlet of the blow dryer.

2. Brief Description of the Prior Art

In the civilized world, a hair or blow dryer is a commonly utilized hand held household appliance. When not in hair drying use, most users of hair dryers consider the placement of the device on the side of sink or under a countertop desirable as a means of temporary storage convenience. Ironically, such placement of hair dryers can often become a hassle; nevertheless hair dryer users have perhaps unconsciously accepted such temporary hair dryer storage or placement for lack of a better solution.

Notably, the placement of a hair dryer in the vicinity of water is a highly dangerous practice, since the hair dryer might inadvertently fall into a sink containing water. Despite the possibility of electrocution, it is very common for homeowners to have a hair dryer within the home in view of its many positive benefits. The present invention attempts to address certain problems associated with the foregoing thoughts.

For example, when mounted on the wall, the hair dryer retainer apparatus according to the present invention provides a hair dryer holder for holding the hair or blow dryer in an elevated position away from water sources. Secondly, when a hair dryer is assembly-held, the user can use it just like an automatic hand dryer. Thirdly, when removed from an assembly-held position, the user can use the hair dryer as desired. Combination hair-hand dryers are known, however, and in this regard, some of the prior art providing combination hair-hand drying functionality and the like are briefly described hereinafter.

U.S. Pat. No. 3,578,000 ('000 Patent), which issued to Horecky, for example, discloses a Combination Manicuring and Hair Drying Appliance. The '000 Patent describes a compact, portable hair dryer and manicure appliance having a housing for a motor-driven blower unit with compartments provided for storing an air delivery hose, a collapsible hair-drying hat, and a manicure attachment including a flexible drive shaft and nail-treating implements. The housing is formed by three molded plastic parts which form the housing with its storage compartments and a closure for two of the compartments.

U.S. Pat. No. 4,195,416 ('416 Patent), which issued to Hall, discloses a Combination Hair/Hand/Body Dryer and Vapor Dispenser. The '416 Patent describes a cabinet adapted to be mounted on a wall of a washroom or similar facility and is provided with a conventional hand-held hair dryer secured within the cabinet and positioned so that the output of the hair dryer is projected through a vent opening in the cabinet. The hair dryer is controlled by a push-button time switch and the push button of the switch is operable from the outside of the cabinet. A suitable vaporizing substance is disposed within the cabinet adjacent to the inlet of the hair dryer so that the fumes are expelled through the vent together with the heated air. Additional electrical circuitry can be provided to override the time switch and to provide power outlets for washroom accessories such as electric shavers or lighting.

U.S. Pat. No. 4,659,907 ('907 Patent), which issued to Andis et al., discloses a Wall Mounted Device with Hand-Held Hair Dryer. The '907 Patent describes a device including a hand-held hair dryer and a hair dryer mount adapted to be attached to a planar support. The mount includes a catch for supporting and releasably preventing detachment of the hair dryer from the mount. In one embodiment, the hand-held hair dryer includes a first end and a second end with an indentation, and the catch includes a lower lever for receiving the first end of the hair dryer and an upper lever for releasably retaining the first end in the lower lever.

The upper lever includes a tab receivable in the indentation. The mount also includes a switch for energizing and de-energizing the hair dryer and a switch actuator for operably connecting the upper lever to the switch. The mount also includes a bar for preventing movement of the upper lever when the lower lever is not engaged by the first end of the hair dryer, and a tab located adjacent the hair dryer on the upper lever for preventing energizing of the hair dryer when the hair dryer is received by the catch.

U.S. Pat. No. 4,802,287 ('287 Patent), which issued to Chen, discloses a Two-Purpose Device of Hand and Hair Dryers. The '287 Patent describes a dual purpose hand and hair dryer, and a cabinet for mounting the hair dryer on a wall for use as a hand dryer. The cabinet has a swing-down front part which receives the hair dryer and which has electric circuitry for operating the hair dryer including a light-sensitive switch and a timer.

U.S. Pat. No. 5,351,417 ('417 Patent), which issued to Rubin, discloses a Hair Dryer Apparatus Adapted for Multi-Functional Usage. The '417 Patent describes a hair dryer adapted for multifunctional use includes a housing which is mounted on a wall and a hand-held dryer connected to a power supply in the housing through an electrical cable. The power supply to the dryer is controlled by the degree of extension of the cable from the housing. The housing is adapted to receive a number of different modules which can be installed with security in the housing. A tumble dryer can be incorporated into the housing. The apparatus can be provided with a switching device which controls the supply of heated air from the dryer to selected heated air utilization devices such as the tumble dryer, a hand and nail dryer, a room heater and a defogger outlet.

U.S. Pat. No. 5,438,763 ('763 Patent), which issued to Yang, discloses a Multipurpose Electric Dryer. The '763 Patent describes a multipurpose electric dryer including a housing covered with a front cover, a blast fan installed in the housing and having an air output port coupled with a fully clad electric positive-temperature-coefficient heater and connected to a first air hole and a second air hole on the front cover, a sliding hanger moved in a vertical sliding way on the front cover, a hot air hose having one end fixedly connected to the second air hole and an opposite end coupled with an airflow nozzle, a shutter linked to the sliding hanger and moved to alternatively open the air holes, a spring fastened to the front cover to pull the shutter away from the second air hole, wherein when the air-flow nozzle is hung on the sliding hanger, the sliding hanger is downward to pull the shutter rightward, causing the shutter to open the first air hole and close said second air hole, permitting hot air be driven out of a front opening on the front cover for drying the hands; when the air-flow nozzle it removed from the sliding hanger, the spring pulls the shutter leftwards to close the first air hole and open the second air hole, permitting hot air be driven out of the air-flow nozzle of the hot air horse for drying the hair.

U.S. Pat. No. 5,568,691 ('691 Patent), which issued to Rubin, discloses a Hair Dryer Apparatus Adapted for Multi-Functional Usage. The '691 Patent describes a multi-functional assembly of a hair dryer in which a base unit is attached to a wall for producing heated air which is supplied to a hand-held dryer. A garment dryer is attachable in the assembly to receive the heated air produced by the base unit. The accessory units are capable of being detachably interconnected with one another and with the base unit in a variety of ways.

The interconnection is made by security connectors to prevent unauthorized disconnection of the units. Electrical power is supplied to circuit boards in the base unit and the electrical power is transmitted to the accessory units when they are connected in the assembly. A ground fault circuit interrupter or similar safety device in the base unit controls electrical supply to all units. When the accessory unit is a garment dryer, the dryer drum is driven by a turbine wheel, driven by heated air. The drive turbine of the wheel is utilized to produce electrical energy to achieve various functions, such as door latching, alarm signal generation, moisture determination, etc.

U.S. Pat. No. 5,842,670 ('670 Patent), which issued to Nigoghosian, discloses a Hair Dryer Support. The '670 Patent describes an apparatus for supporting an electrical hair dryer or other electrical implement having an elongated portion. The apparatus includes a base from which projects a flexible tube. At the other end of the flexible tube a hair dryer holder is arranged to receive a hair dryer. When the hair dryer is inserted into the holder, the flexible tube may be positioned into any of a number of various orientations. This provides the user with enhanced operability of the stand, because the user may arrange the flexible tube in a variety of positions.

U.S. Pat. No. RE 36,995 ('995 Patent), which issued to Andis, discloses a Hand Held Appliance and Holder Assembly. The '995 Patent describes a hand held appliance and holder assembly comprising a holder including means adapted for mounting to a supporting surface, a first end portion, a second end portion, and a cradle portion intermediate the end portions, and a hand held appliance including a handle portion including an inner end, an outer end releasably engaged by one of the end portions, and an intermediate part located between the inner and outer ends, received in the cradle portion, and including an off-on switch including a member moveable between an off position and an on position and being displaceable to the off position incident to receipt of the intermediate part into the cradle portion, and an operating portion attached to the inner end of the handle portion and releasably engaged by the other of the end portions.

United States Patent Application No. 2005/0258114, which was authored by Davis, describes a wall mounted caddie used to support a portable hair dryer and its accessories. The caddie is designed to turn the standard hair dryer into a wall mounted hand dryer. The caddie has an electrical cord that plugs into the standard wall socket and has a socket built into the caddie where the hair dryer is plugged. Once the hair dryer is plugged into the caddie and the caddie is plugged into the wall socket, a laser mounted at the base of the caddie is activated and is used to turn the hair dryer into a hand dryer. From a consideration of the foregoing, it will be noted that the prior art appears to be silent on a combination blow dryer and docking apparatus comprising programmable motion detection and means for powering the blow dryer based on blow dryer and/or hand position(s). Accordingly, the prior art perceives a need for a blow dryer retainer or docking apparatus of the foregoing type, which apparatus and combination is described and/or summarized in more detail hereinafter.

### SUMMARY OF THE INVENTION

It is an object of the present invention to provide a blow dryer docking apparatus that operates to receive and position a blow dryer in a “pointing down” direction, along with an infrared sensor built into the docking apparatus that detects whether there is a human hand present adjacent the output end of the blow dryer.

If a user's hand is detected, the docking apparatus powers on the blow dryer after a short delay. The blow dryer remains in a powered state as long as there is motion (e.g. by a user's hands) adjacent the output end of the blow dryer. If an object adjacent the output end of the blow dryer becomes stationary, the hair dryer shuts down after a period of time until the object is removed and re-positioned under the sensor.

The specifications thus call for programmable motion detection with a one second “ON” delay; a five second “OFF” delay; and a forty second maximum run time for any given blow drying event (e.g. if object within sensor range becomes stationary). Excellent results have been achieved by providing a sensing range of up to about 4 inches distance between a user's hand(s) and the sensor.

The frequency on which the preferred motion detection inputs are based is preferably on the order of one or two cycles per second. The order of frequency is believed adequate based on the fact that anatomical hand motion is typically much slower than digital circuit signals. The frequency could conceivably be adjusted, however, to be slightly more or less frequent.

When a blow dryer is positioned by the blow dryer retainer assembly and a hand is present within the sensing range of certain motion sensing means, the blow dryer retainer or docking assembly powers on the blow dryer apparatus so long as there is motion within the sensing range. If hands are removed from sensing range, the unit shuts off after a five second delay. If there is stationary object, the unit will shut down after forty seconds.

The combination of components is essentially divided into several sub-assemblies as generally depicted in Figure No. 8. In this last regard, it should be understood that the infrared input circuit essentially provides information as to whether a user's hand is present. The microcontroller is governed by a motion detection algorithm, the output from which controls a relay to control power delivery to the positioned blow dryer.

The present invention thus contemplates the use of a microcontroller to essentially process motion detection input data. Data is input to the microcontroller from an infrared light sensing device having a port at the bottom akin to typical stand-alone hand-drying devices. Further, and importantly, the ensemble includes a position switch to allow the docking station to power on the blow dryer when it is removed from the docking station or apparatus.

When removed from the docking station, the blow dryer is operated as if powered from a wall socket-based power source. The blow dryer, however, is microcontroller controlled when it is releasably retained by the blow dryer retainer assembly or apparatus according to the present invention. The shell of the docking station or apparatus must accommodate the hand dryer function, but is contemplated to essentially include a water proof box as at 30 holding all circuit elements 102 inside. Two circular rings or brackets function to hold the blow dryer in place, so the user will place blow dryer with the air output end pointing down. The overall shape of the box 30 and/or supporting elements may be well enhanced for providing an aesthetically pleasing design.

### BRIEF DESCRIPTION OF THE DRAWINGS

Other features of my invention will become more evident from a consideration of the following brief descriptions of patent drawings:

Figure No. 1 is a first top perspective view of a blow dryer retainer assembly or apparatus according to the present invention showing a phantom blow dryer assembly-positioned by the blow dryer retainer assembly.

Figure No. 2 is a second top perspective view of a blow dryer retainer assembly or apparatus according to the present invention showing a blow dryer assembly-positioned by the blow dryer retainer assembly.

Figure No. 3 is a third top perspective view of a blow dryer retainer assembly or apparatus according to the present invention showing a blow dryer exploded from the retainer assembly.

Figure No. 4 is a first side view of the blow dryer retainer assembly according to the present invention showing a blow dryer assembly-positioned by the retainer assembly with parts of the retainer assembly and blow dryer broken away to diagrammatically depict otherwise hidden circuitry.

Figure No. 4(a) is an enlarged view of a position switch as enlarged from Figure No. 4 showing the position switch with parts broken away to diagrammatically depict the switch in an open switch position while in an resiliently actuated state.

Figure No. 5 is a second side view of the blow dryer retainer assembly according to the present invention showing a blow dryer exploded from the retainer assembly with parts of the retainer assembly and blow dryer broken away to diagrammatically depict otherwise hidden circuitry.

Figure No. 5(a) is an enlarged view of the position switch as enlarged from Figure No. 5 showing the position switch with parts broken away to diagrammatically depict the switch in a closed switch position while in a resiliently relaxed state.

Figure No. 6 is a third side view of the blow dryer retainer assembly according to the present invention showing a blow dryer assembly-positioned with the retainer assembly being shown plugged into a wall socket as a power source.

Figure No. 7 is a fourth side view of the blow dryer retainer assembly according to the present invention showing a blow dryer assembly-positioned with the blow dryer being shown plugged into an assembly socket as a power source.

Figure No. 8 is a box type diagram of the overall system according to the present invention showing directed flow of signal input(s) and output.

Figure No. 9 is a symbolic box type diagram of an infrared input module showing preferred signal flow from infrared sensor to PIC microcontroller.

Figure No. 10 is a bubble flow chart type diagram of the preferred motion detection algorithm according to the present invention.

Figure No. 11 is a symbolic output circuit diagram showing an output pin of the PIC microcontroller drives a generic NPN transistor opposite a static resistance, which transistor drives a relay as enabled by way of a position switch.

Figure No. 12 is a fourth top perspective view of a blow dryer retainer assembly according to the present invention showing a blow dryer exploded from the retainer assembly and depicting an air flow axis of the blow dryer being re-directable in three dimensions.

Figure No. 12(a) is an enlarged, fragmentary view of a first conduit retention bracket as viewed along its axis to depict the inner diameter of the first conduit retention bracket.

Figure No. 12(b) is an enlarged, fragmentary view of a second conduit retention bracket as viewed along its axis to depict the inner diameter of the second conduit retention bracket.

### DETAILED DESCRIPTION OF THE PREFERRED EMBODIMENT(S)

Referring now to the drawings with more specificity, the present invention essentially provides a blow dryer retainer apparatus 11 for use in combination with a blow dryer 10 for enabling a user to selectively dry articles either in a hand-held dynamic blow drying mode (e.g. for drying one's hair) or an assembly-held static blow drying mode (e.g. for drying one's hands). When viewed in combination, the dryer assembly according to the present invention is thus believed to essentially comprise a blow dryer apparatus as at 10, and a blow dryer retainer assembly or apparatus as at 11.

The blow dryer apparatus 10 according to the present invention is contemplated to be any electromechanical device designed to direct forced air (heated or of an ambient temperature) over wet or damp material (most typically hair) in order to accelerate the evaporation of water particles from the material in order to dry the same. Typically, a blow dryer or hairdryer apparatus as generally depicted and referenced at 10 incorporates coils of wire that have a high electric resistivity and heat rapidly with an electric current (i.e. a heating element as symbolically depicted at 13).

Certain air forcing means as typically exemplified by a fan assembly usually blows ambient air (as at vectors 105) past the hot coils or heating element 13 resulting in a heated air flow (as at vectors 104) and air flow output 106 effective for drying. In this last regard, it is thus contemplated that the blow dryer apparatus 10 according to the present invention necessarily comprises certain air-forcing means as diagrammatically depicted at 12, as well as preferred air-heating means as diagrammatically depicted at 13.

The air-heating means or heating element 13 in most typical blow dryers or hairdryers is a bare, coiled nichrome wire that is wrapped around insulating mica heating boards. Nichrome wire is used in heating elements, because of two important properties: it is a poor conductor of electricity and it does not oxidize when heated. Despite the prevalence of nichrome based heating elements, it is noted that ceramic (i.e. molybdenum silicide) heating elements have gained in popularity due to their ability to provide relatively instantaneous heat.

The blow dryer apparatus 10 according to the present invention further preferably comprises certain air conduit for directing and/or conducting (preferably heated) air flow along an air flow axis as at 100, as well as the necessary apparatus circuitry (as diagrammatically depicted at 101) for powering the air-heating means 13 and the air-forcing means 12 (not necessarily in parallel circuit). The air conduit is most typically defined by a blow dryer shaft as at 14, which shaft 14 comprises a shaft axis substantially coaxial with the air flow axis 100.

It may be understood from consideration of Figure No. 11 that the blow dryer apparatus 10, when held by hand, may be manually re-directed as the user may elect to direct the air flow axis 100 toward the material to be blow-dried. In this regard, rotational arrows 114 showing movement in three dimensions are depicted to diagrammatically show that the air flow axis 100 of the blow dryer apparatus 10 may be selectively placed into a dynamic drying mode whereby the axis 100 is re-directable as the user may elect.

Should the user wish to place the blow dryer apparatus into a static drying mode whereby the air flow axis 100 is fixed, the user may releasably mount the blow dryer apparatus 10 to the blow dryer retainer or docking assembly as at 11. In this regard, the retainer assembly or docking apparatus 11 preferably comprises certain conduit positioning means for selectively positioning the air conduit as exemplified by shaft 14 of the blow dryer apparatus 10.

It is contemplated that the conduit positioning means may be preferably exemplified by a first conduit retention bracket 15 and a second conduit retention bracket 16. The air conduit or shaft 14 of the blow dryer apparatus 10 may thus be releasably retained by the conduit retention brackets 15/16 such that an air outlet end 17 of the air conduit or shaft 14 is releasably retained by the first conduit retention bracket 15 and a second portion or section 18 of the air conduit or shaft 14 is releasably retained by the second conduit retention bracket 16.

The air conduit or shaft 14 of the blow dryer apparatus 10 may preferably comprise certain generally frustoconical exterior surfacing as at 20. The first and second conduit retention brackets 15 and 16 respectively comprise first and second inner diameters as at 107 and 108. The first and second inner diameters 107 and 108 respectively receive and engage first and second outer diameters 109 and 110 of the frustoconical exterior surfacing 20. The first inner and outer diameters 107 and 109 are lesser in magnitude than the second inner and outer diameters 108 and 110 for enabling the air conduit or shaft 14 to seat within the first and second brackets 15 and 16.

The first and second conduit retention brackets 15 and 16 further comprise first and second axis-to-sensor spacing structures as at 23 and 24. The axis-to-sensor spacing structures 23/24 essentially function to maintain the air flow axis 100 in fixed spaced relation relative to certain motion-sensing means as diagrammatically depicted and referenced at 26, which means 26 are preferably incorporated into the retainer assembly or docking apparatus 11.

Preferably, the first and second brackets 15/16 function to space the air flow axis 100 between 1 and 4 inches from the motion sensing means 26 as well as maintain the air flow axis 100 in fixed relation when the blow dryer apparatus 10 is releasably mounted by the retainer apparatus 11 and structurally situated in the assembly-held, static drying mode as generally depicted in Figure Nos. 1, 2, 4, 6, and 7.

The motion-sensing means 26 are preferably exemplified by a SHARP brand GP2D120XJ00F infrared sensor due to its desirable sensing range. Notably, this motion sensor works well within the range of 1 to 4 inches, the infrared output versus hand distance being summarized as follows: 1.2V Vₒᵤₜ at 0 inches; 2.7V Vₒᵤₜ at 1 inch; 2.2V Vₒᵤₜ at 2 inches; 1.6V Vₒᵤₜ at 3 inches; and 1.1V Vₒᵤₜ at 4 inches.

The output connector from the motion sensor as at 26 preferably connects to a 10 pF capacitor to filter out the high frequency noise generated by the diode-protected motion sensor. The noted Vₒᵤₜ values are translated into a 10 bit threshold value for the microcontroller or signal processing means.

The motion sensing means 26 thus function to sense motion (as at 111) adjacent the air output end 17 of the blow dryer apparatus 10, the static drying mode being enabled by way of said motion sensing means 26. As noted, the motion sensing means 26 may be preferably defined by an active infrared sensor. In this regard, the preferred infrared light-sensing means function to both (1) transmit an infrared signal, and (2) receive reflected infrared signal as reflected from an object passed in front of the sensor (within the preferred sensing range). The preferred infrared sensor will thus operate on objects regardless of the thermal signature of the sensed object.

The preferred infrared sensor may thus be distinguished from a passive infrared sensor. A passive infrared sensor essentially functions to receive infrared light (as diagrammatically depicted at 112) from thermally radiant objects (e.g. a human hand 113) passed thereby. Thus, it is contemplated that infrared light sensing aspects of the sensing means 26 may alternatively enhance directed air flow toward thermally radiant human anatomy, as opposed to relatively cooler, non-anatomical objects.

As prefatorily described hereinabove, the motion sensing means 26 are in communication with certain signal processing means as may be preferably exemplified by a PIC16F877A microcontroller. The finite state machine, as diagrammatically depicted in Figure No. 10, uses a polling method for motion detection which uses up all clock cycles of the processor.

It is noted that while the interrupt method may yield a comparable result, the polling method coding is relatively easier and less elaborate. The signal processing means thus essentially function to receive input signals from the motion sensing means 26 and selectively output output-governing signals based on the received input signals for selectively controlling air flow output (as at 106) from the blow dryer apparatus 10 along the air flow axis 100.

As may be seen from a consideration of Figure No. 10, the motion detection algorithm preferably comprises several time definitions, where T1 represents 1 second; T2 represents 5 seconds; and T3 represents 40 seconds. The retainer apparatus or docking assembly 11 operates to detect a user's presence by way of the motion sensing means 26. If the user's hand is within 4 inches from the motion sensing means 26, the voltage will output above a threshold voltage to which the microcontroller is pre-set.

If the user's hands are within the defined Vₒᵤₜ range, voltage will read above a threshold voltage and the microcontroller will process a blow drying event. If the user's hands are not within the range, the microcontroller will not process a blow drying event. T1 is the time length from when the user first presented the hand under the motion sensing means 26 to the time the retainer apparatus 11 will go into state 1 which state turns on the unit to start drying user's hands.

T2 is 5 seconds and represents a time delay. In other words, when a blow drying event has been initiated, and the user's hand is removed from the motion-sensing range, the logic will operate as if the input has been removed, and will continue the blow drying event for 5 seconds longer. If, during the delay of 5 seconds, the user's hands are not placed back into the motion sensing range, the retainer apparatus or docking assembly 11 will discontinue the blow drying event (i.e. will shut off of the blow dryer apparatus 10).

T3 is 40 seconds, which time length represents the maximum amount of time for a blow drying event. In other words, it is the time limit for an object that is detected within the motion sensing range and continuously supplied an input signal. Thus, if a thermally radiant object is presented under the unit and is never removed from the sensor range, the unit will continue the blow drying event for 40 seconds, and turn off after that point. The unit will not turn back on again unless the object is removed from the sensor range and re-presented to the sensor range.

Notably, the motion sensing logic is such that if user is moving his or her hand(s) under the unit including rubbing hands together or flipping hands while trying to dry the hands evenly, it is contemplated that such continuous motion will involve hand movement in and out of the sensing range. Therefore, when the unit is turned on (i.e. T3 timer is set) and within the 40 second maximum blow drying event, the user moves his or her hands away from sensor, the unit will sense a stop event and the T2 timer will be set (5 seconds), whereafter the unit will remain “on” for 5 seconds.

If the user is still using the ensemble, the user will still have motion in the hands before the expiration of 5 seconds. Once the unit again detects motion before the expiration of a 5-second delay, the unit will re-set the T3 timer (another 40 seconds). Essentially, it is contemplated that if the user keeps re-setting the 40 second timer by moving the user's hands into and out of the sensor range. When the user has finished drying the user's hands, the user will permanently remove the user's hands from the sensor range and the unit will turn off after a 5 second delay.

A 6V, 400 mA AC to DC power supply may be used in combination with a 7805 voltage regulator to supply 5V to the circuitry 102. The output circuit diagram is generally depicted in Figure No. 11. The output pin of the PIC microcontroller drives a generic NPN transistor. A 1 kilo ohm resistor connects between its base and output pin of the PIC microcontroller to limit current to 4 mA. The transistor in turn drives a relay to deliver the 15A required to power the blow dryer apparatus 10.

The retainer apparatus 11 further preferably comprises certain position switching means for switching apparatus-driving circuitry when the air conduit or shaft 14 is positioned by the retention brackets 15 and 16. It is contemplated that the position switching means may preferably be exemplified by a single pole double throw micro switch as generally referenced at 22, which switch 22 is resiliently biased in a closed switch position as generally depicted in Figure Nos. 5 and 5(a).

The position switching means as at 22 according to the present invention thus preferably comprise certain resilient means as exemplified by spring element 21 for resiliently engaging the exterior surfacing 20 of the air conduit or shaft 14. From a comparative inspection of Figure Nos. 4 and 4(a) versus Figure Nos. 5 and 5(a), the resilient member or element 21 has a closed switch position when in a relaxed state as generally depicted in Figure No. 5(a) and an open switch position when in an actuated state as generally depicted in Figure No. 4(a). The closed and open switch positions function to selectively power the blow dryer apparatus 10 based on the position of the exterior surfacing 20.

To power the blow dryer apparatus 10, the retainer apparatus 11 necessarily further comprises apparatus-driving circuitry as heretofore specified and as generally depicted by a generic box 102 for selectively and electrically powering the blow dryer apparatus 10 while either in a hand-held, dynamic drying mode or an assembly-held static drying mode.

The apparatus circuitry 101 and apparatus-driving circuitry 102 are electrically communicable with one another and with a power source 115 as typified by a wall socket as at 103. The retainer apparatus or docking assembly 11 thus contemplates a power cord as at 17 for electrically communicating the retainer apparatus 10 to a power source 105 via socket 103 for purposes of the present descriptions, and as a means to exemplify how the assembly may be powered.

In this last regard, it is further contemplated that if certain modifications were to be made to the assembly to hard wire the unit as a restroom fixture (as an example), building codes may require that the power cord 25 be directly soldered to the circuit board within box 102 and the external surfacing of the box 30 made waterproof. It should thus be noted that certain aspects of the drawings are illustrated as being exemplary or typical and demonstrative of the general underlying concepts.

Notably, blow dryers (of the type contemplated usable in combination with the retainer assembly 11) typically comprise their own power cord (as at 25) for plugging into a wall socket as at 103. The retainer assembly 11 thus contemplates at least one socket as at 19, which socket 19 may be placed into electrical communication with socket 103 via apparatus-driving circuitry 102, which circuitry has heretofore been described.

While the foregoing specifications set forth much specificity, the same should not be construed as setting forth limits to the invention but rather as setting forth certain preferred embodiments and features. For example, as prefaced hereinabove, it is contemplated that the present inventive subject matter essentially provides a blow dryer retainer apparatus as at 11 for enabling a user to selectively maintain the air flow axis 100 of an apparatus-retained or assembly-held blow dryer as at 10.

The blow dryer retainer apparatus 11 according to the present invention is believed to essentially comprise certain blow dryer positioning means for selectively positioning a blow dryer 10; certain position switching means as at 22 for switching apparatus-driving circuitry when a blow dryer 10 is positioned by said blow dryer positioning means; and certain apparatus-driving circuitry for selectively and electrically powering a positioned blow dryer 10. The positioned blow dryer is electrically communicable with the apparatus-driving circuitry and selectively operable thereby via a power source.

The blow dryer positioning means may be preferably defined by first and second conduit retention brackets as at 15 and 16 for releasably retaining first and second conduit portions (as at 17 and 18) of the blow dryer 10 for opposing moments of force and maintaining the air flow axis 100 of the positioned blow dryer 10. The first and second conduit portions 17 and 18 may preferably comprise varied outer diameters (as at 109 and 11) of the exterior conduit surfacing 20, which varied diameters are received by varied inner diameters 107 and 108 of the brackets 15 and 16.

The position-switching means as exemplified by position switch 22 may preferably be located intermediate the first and second conduit retention brackets 15 and 16 and comprise resilient means for adjustably engaging the exterior surfacing 20 of the blow dryer shaft 14. The resilient means preferably have a closed switch position when in a relaxed state and an open switch position when in an actuated state. The closed and open switch positions essentially function to selectively power the blow dryer 11 when used in either a hand-held, dynamic drying mode or in an assembly-held, static drying mode.

The blow dryer retainer apparatus 11 preferably further comprises certain motion sensing means as at 26 for sensing motion adjacent an air output end 17 of the positioned blow dryer 10. Sensed motion operates to selectively power the positioned blow dryer 10. The motion sensing means 26 may comprise or be defined by certain infrared light-sensing means for receiving infrared light (as at 112) from thermally radiant objects passed thereby. It is contemplated that the infrared light sensing means may well function to enhance directed air flow 106 toward thermally radiant human anatomy.

The motion sensing means 26 are preferably in communication with certain signal processing means, which signal processing means function to receiving input signals from the motion sensing means and selectively output signals based on the received input signals. The output signals selectively control air flow output from the blow dryer apparatus 10 along the air flow axis 100.

It will be seen from an inspection of the drawings that the motion sensing means having a generally vertical axis of orientation (i.e. the sensor is angled so as to direct and receive infrared vertical signal(s)). The axis of orientation, as shown, should not be construed as limiting. It is contemplated, for example, that the axis of orientation could very well be angled toward the user oblique to the frontal plane of the box 30.

In addition to the foregoing electromechanical structural considerations, it is contemplated that the same support certain blow drying methodology. In this regard, it is contemplated that the blow drying method according to the present invention may well enable a user to direct heated air flow either dynamically or statically as the user may elect. The blow drying method may be said to comprise the initial steps of providing a hand held blow dryer apparatus, and a blow dryer retainer apparatus.

The blow dryer apparatus preferably comprises certain air-heating means for heating air; certain air-forcing means for directing heated air; certain air conduit for conducting directed heated air along an air flow axis; and certain circuitry for powering said air-heating and air-forcing means.

The blow dryer retainer assembly preferably comprises certain conduit positioning means for selectively positioning said air conduit; certain apparatus-driving circuitry for selectively and electrically powering the blow dryer apparatus; and certain position switching means for switching apparatus-driving circuitry when said air conduit is positioned by said conduit positioning means.

The blow dryer apparatus may be selectively held by one's hand for manually and dynamically changing the direction of the air flow axis; and/or may be selectively retained via the blow dryer retainer apparatus for mechanically and statically maintaining the direction of the air flow axis.

The blow drying method may further comprise the step of sensing motion adjacent the air output end of the blow dryer apparatus via certain motion sensing means cooperable with the blow dryer retainer apparatus, which motion sensing means essentially function to govern air flow along the statically maintained air flow axis. Infrared light may be sensed from thermally radiant objects passed adjacent the air output end via certain infrared sensing means for enhancing directed air flow toward thermally radiant human anatomy.

The blow drying method may preferably further comprise the steps of: processing input signals from the motion sensing means via signal processing means, and outputting processed signals based on the input signals for selectively controlling air flow output from the blow dryer apparatus along the air flow axis. The signal processing means may be governed by a motion detection algorithm incorporating time delays and resets for enhancing controlled output from the blow dryer apparatus 10.

In summary, it is believed that the combination hair-hand dryer assembly according to the present invention provides a multi-purpose docking station with an attached blow dryer that may be mounted on bathroom wall as at 116. The ensemble allows the user to use the blow dryer as an automatic hand dryer when the blow dryer is releasably retained by the blow dryer retainer apparatus or docking station.

The blow dryer retainer apparatus 11 automatically powers on the blow dryer 10 when the blow dryer 10 is released or removed from the apparatus 11 for drying hair. Further, the blow dryer retainer apparatus 11 automatically shuts down and switches to a hand drying mode when the blow dryer 10 is releasably retained by the apparatus 11. The apparatus 11 thus provides a convenient storage function for the blow dryer 10. The apparatus further employs a motion detection algorithm to avoid accidental turn on, and automatic shut off if a stationary object is present in sensor range.

Accordingly, although the present invention has been described by reference to certain preferred systemic arrangements and certain methodologies, it is not intended that the novel arrangements and methods be limited thereby, but that modifications thereof are intended to be included as falling within the broad scope and spirit of the foregoing disclosures and the appended drawings.

I claim:

1. A combination dryer assembly for enabling a user to selectively dry articles either in a hand-held, dynamic drying mode or an assembly-held, static drying mode, the dryer assembly comprising, in combination:
a blow dryer apparatus, the blow dryer apparatus comprising air-forcing means for directing air; air conduit for conducting directed air along an air flow axis; and apparatus circuitry for powering said air-forcing means; and
a retainer assembly, the retainer assembly comprising conduit positioning means for selectively positioning said air conduit; position switching means for switching apparatus-driving circuitry when said air conduit is positioned by said conduit positioning means; and apparatus-driving circuitry for selectively and electrically powering the blow dryer apparatus either in a hand-held, dynamic drying mode or an assembly-held, static drying mode, the apparatus and apparatus-driving circuitry being in electrical communication and communicable with a power source for powering said blow dryer apparatus.

2. The dryer assembly of claim 1 wherein the conduit positioning means comprise first and second conduit retention brackets, the air conduit being releasably retained by the conduit retention brackets such that an air outlet end of the air conduit is releasably retained by the first conduit retention bracket and a second portion of the air conduit is releasably retained by the second conduit retention bracket, the first and second conduit retention brackets for selectively maintaining the air flow axis of the air conduit while in the assembly-held, static drying mode.

3. The dryer assembly of claim 2 wherein the air conduit comprises frustoconical exterior surfacing, the first and second conduit retention brackets respectively comprising first and second inner diameters, the first and second inner diameters for respectively receiving and engaging first and second outer diameters of the frustoconical exterior surfacing, the first inner and outer diameters being lesser in magnitude than the second inner and outer diameters for enabling the air conduit to seat within the first and second conduit retention brackets.

4. The dryer assembly of claim 3 wherein the position switching means comprise resilient means for adjustably engaging the frustoconical exterior surfacing, the resilient means having a closed switch position when in a relaxed state and an open switch position when in an actuated state, the closed and open switch positions for selectively powering the blow dryer apparatus.

5. The dryer assembly of claim 4 wherein the retainer assembly comprises motion sensing means for sensing motion adjacent the air output end, the static drying mode being enabled by way of said motion sensing means.

6. The dryer assembly of claim 5 wherein said motion sensing means are defined by infrared light sensing means.

7. The dryer assembly of claim 6 wherein the motion sensing means are in communication with signal processing means, the signal processing means for receiving input signals from the motion sensing means and selectively outputting output-governing signals based on the received input signals, the output-governing signals for selectively controlling air flow output from the blow dryer apparatus along the air flow axis.

8. The dryer assembly of claim 7 wherein the motion sensing means are spaced from the air flow axis by way of the first and second conduit retention brackets, the first and second conduit retention brackets comprising axis-to-sensor spacing structures for spacing the air flow axis between 1 and 4 inches from the motion sensing means.

9. A blow dryer retainer apparatus for enabling a user to selectively maintain the air flow axis of an apparatus-retained blow dryer, said apparatus comprising:
blow dryer positioning means for selectively positioning a blow dryer;
position switching means for switching apparatus-driving circuitry when a blow dryer is positioned by said blow dryer positioning means; and
apparatus-driving circuitry for selectively and electrically powering a positioned blow dryer, the positioned blow dryer being electrically communicable with the apparatus-driving circuitry and selectively operable thereby via a power source.

10. The blow dryer retainer apparatus of claim 9 wherein the blow dryer positioning means comprise first and second conduit retention brackets, the conduit retention brackets for releasably retaining first and second conduit portions of the blow dryer for opposing moments of force and maintaining the air flow axis of the positioned blow dryer.

11. The blow dryer retainer apparatus of claim 9 wherein the position-switching means comprise resilient means for adjustably engaging exterior surfacing of the blow dryer, the resilient means having a closed switch position when in a relaxed state and an open switch position when in an actuated state, the closed and open switch positions for selectively powering the positioned blow dryer.

12. The blow dryer retainer apparatus of claim 9 wherein the retainer assembly comprises motion sensing means for sensing motion adjacent an air output end of the positioned blow dryer, sensed motion for selectively powering the positioned blow dryer.

13. The blow dryer retainer apparatus of claim 12 wherein said motion sensing means comprise infrared light sensing means.

14. The blow dryer retainer apparatus of claim 12 wherein the motion sensing means are in communication with signal processing means, the signal processing means for receiving input signals from the motion sensing means and selectively outputting output-governing signals based on the received input signals, the output-governing signals for selectively controlling air flow output from the blow dryer apparatus along the air flow axis.

15. A blow drying method, the blow drying method for enabling a user to selectively direct air flow either dynamically or statically, the blow drying method comprising the steps of:
providing a hand held blow dryer apparatus, the blow dryer apparatus comprising air-forcing means for directing air; air conduit for conducting directed air along an air flow axis; and circuitry for powering said air-forcing means;
providing a retainer assembly, the retainer assembly comprising conduit positioning means for selectively positioning said air conduit; apparatus-driving circuitry for selectively and electrically powering the blow dryer apparatus; and position switching means for switching apparatus-driving circuitry when said air conduit is positioned by said conduit positioning means;
selectively holding the blow dryer apparatus by one's hand for manually and dynamically changing the direction of the air flow axis; and
selectively retaining the blow dryer apparatus via the retainer assembly for mechanically and statically maintaining the direction of the air flow axis.

16. The blow drying method of claim 15 wherein the conduit positioning means comprise first and second conduit retention brackets, the air conduit being releasably retained by the conduit retention brackets such that an air outlet end of the air conduit means are releasably retained by the first conduit retention bracket and a second portion of the air conduit means are releasably retained by the second conduit retention bracket, the first and second conduit retention brackets for selectively maintaining the air flow axis of the air conduit when selectively retained by the retainer assembly.

17. The blow drying method of claim 15 wherein the position switching means comprise resilient means for adjustably engaging exterior surfacing of said air conduit, the resilient means having a closed switch position when in a relaxed state and an open switch position when in an actuated state, the closed and open switch positions for selectively powering the blow dryer apparatus via the retainer assembly.

18. The blow drying method of claim 15 comprising the step of sensing motion adjacent an air output end of the blow dryer apparatus via motion sensing means cooperable with the retainer assembly, the motion sensing means directing air flow along the statically maintained air flow axis.

19. The blow drying method of claim 18 comprising the step of sensing infrared light via infrared sensing means.

20. The blow drying method of claim 18 comprising the steps of: processing input signals from the motion sensing means via signal processing means, and outputting processed signals based on the input signals for selectively controlling air flow output from the blow dryer apparatus along the air flow axis.
